(19) United States
(12) Patent Application Publication
(10) Pub. No.: US 2015/0187502 A1
(43) Pub. Date: Jul. 2, 2015

(54) CAPACITOR MODULE, METHOD FOR MANUFACTURING THE SAME, AND INVERTER FOR VEHICLE HAVING THE SAME

(71) Applicant: HYUNDAI MOBIS CO., LTD., Seoul (KR)

(72) Inventor: Jun-Ha Hwang, Yongin-si (KR)

(73) Assignee: HYUNDAI MOBIS CO., LTD., Seoul (KR)

(21) Appl. No.: 14/290,871

(22) Filed: May 29, 2014

(30) Foreign Application Priority Data
Dec. 31, 2013 (KR) 10-2013-0168240

(51) Int. Cl. H01G 4/38; H01G 4/12; H01G 2/04

(52) U.S. Cl. CPC H01G 4/38; H01G 2/04; H01G 4/12

(57) ABSTRACT

A capacitor module may include a case configured to have an open portion formed one surface thereof, and a multi-layer ceramic capacitor array provided in an inside of the open portion and configured to include a plurality of multi-layer ceramic capacitors (MLCCs) disposed therein.

### CROSS-REFERENCE TO RELATED APPLICATION

This application claims benefit of priority to Korean Patent Application No. 10-2013-0168240 filed on Dec. 31, 2013, the entire contents of which are incorporated herein by reference in its entirety.

### TECHNICAL FIELD

Exemplary embodiments of the present invention relate to a capacitor module, and particularly, to a capacitor module to which a multi-layer ceramic capacitor (MLCC) is applied, and a method for manufacturing the same.

In addition, exemplary embodiments of the present invention relate to an inverter for a vehicle employing a capacitor module to which a multi-layer ceramic capacitor is applied.

### BACKGROUND

In an inverter for a vehicle, a direct current (DC) capacitor is electrically coupled in parallel between a battery and an insulated gate bipolar mode transistor (IGBT) to smooth power and absorb switching noise, thereby stabilizing a power system. Such a DC capacitor is generally configured with a film-type capacitor having excellent durability.

Generally, a film-type capacitor has been used in the form of a module by winding, cutting, and compressing a metal-deposited polypropylene film, and then putting the compressed film in a PolyPhenylene Sulfide (PPS) case.

However, since the film-type capacitor is heavy and large, although having excellent durability, the film-type capacitor is disadvantageous in reducing the size and weight of an inverter. In addition, the film-type capacitor is a weak point in terms of fuel efficiency of vehicles.

In addition, when a temperature specification of 100° C. or higher is required, the cost of film material increases sharply, so that the film-type capacitor is a large weak point in terms of material cost.

Accordingly, attempts have been made to substitute such a film-type capacitor with a multi-layer ceramic capacitor (MLCC).

However, the multi-layer ceramic capacitor (MLCC) is used only for a low capacitance (or low current), and is mounted on a low voltage printed circuit board (PCD) to be used in the form of packaging. Such a package form is shown in FIG. 1.

Referring to FIG. 1, a plurality of patterns 111, 112 and 113 are formed on a PCB 110, and a plurality of multi-layer ceramic capacitors (MLCCs) 141 and 142 are mounted side by side by soldering on the plurality of patterns 111, 112 and 113. In addition, lead portions 120 and 121 are electrically coupled to the plurality of patterns 111, 112 and 113 by soldering.

However, when the multi-layer ceramic capacitors of the packaging scheme are used as DC capacitors for vehicles, the sizes of multi-layer ceramic capacitors increase several ten times in order to increase the capacitance thereof from several μF to several hundred μF.

In addition, the packaging scheme in which an MLCC of a small capacitor is soldered and used for a digital circuit on a PCB causes a poor capability under the circumstance of a vehicle, including vibration, impact, thermal shock, and the like.

### SUMMARY

An embodiment of the present invention is directed to a capacitor module which can have an enough capacitance while being small in size, and a method for manufacturing the same.

Another embodiment of the present invention is directed to a capacitor module for providing a packaging design by taking vibration, impact, and temperature characteristics, which are important in a high-voltage and/or high-current circuit, into consideration, and a method for manufacturing the same.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

Provided is a capacitor module which has an enough capacitance while being small in size.

In accordance with an embodiment of the present invention, a capacitor module includes: a case configured to have an open portion formed one surface thereof; and a multi-layer ceramic capacitor array provided in an inside of the open portion, and configured to include a plurality of multi-layer ceramic capacitors (MLCCs) disposed therein.

In this case, the multi-layer ceramic capacitor array may include: a plurality of bus bars; and the plurality of multi-layer ceramic capacitors configured to have a pair of lead portions which are formed at both sides of a lower end thereof so as to be bonded on the plurality of bus bars.

In addition, the bonding may be achieved in a soldering manner.

In addition, the plurality of multi-layer ceramic capacitors may have a large capacitance.

In addition, the plurality of multi-layer ceramic capacitors may be configured such that each multi-layer ceramic capacitor is implemented in a unit of 20 to 40 μF on capacitance.

In addition, material of the plurality of bus bars may be one of aluminum and aluminum alloy.

In addition, material of the case may include one or more selected from the group consisting of PolyPhenyleneSulfide (PPS), Carbon Fiber-Reinforced Plastic (CFRP), PolyButylene Terephthalate (PBT), PolyMethylMethAcrylate (PMMA), PolyAmide (PA), and PolyOxyMethylene (POM) resin.

In addition, the open portion may be filled with molding material and be heat-cured after the multi-layer ceramic capacitor array is mounted.

In addition, the molding material may belong to an epoxy resin series or a silicone resin series.

In addition, the plurality of multi-layer ceramic capacitors may be electrically coupled in series to each other.

In accordance with another embodiment of the present invention, an inverter for a vehicle includes: a housing; a switching element mounted on a bottom surface of the housing; and a capacitor module electrically coupled to the switching element, wherein the capacitor module comprises: a case configured to have an open portion formed one surface thereof; and a multi-layer ceramic capacitor array provided in an inside of the open portion, and configured to include a plurality of multi-layer ceramic capacitors (MLCCs) disposed therein.

In this case, the inverter for a vehicle may be one of an inverter integrated with a driving shaft and an inverter integrated with a wheel.

In accordance with another embodiment of the present invention, a method for manufacturing a capacitor module includes: disposing a plurality of bus bars at a predetermined interval; bonding a plurality of multi-layer ceramic capacitors on the plurality of bus bars to generate a multi-layer ceramic capacitor array; mounting the multi-layer ceramic capacitor array on a case; and filling the case with molding material.

### BRIEF DESCRIPTION OF THE DRAWINGS

FIG. 1 is a conceptual view illustrating the configuration of a normal low-capacitance multi-layer ceramic capacitor package;

FIG. 2 is a conceptual view illustrating the configuration of a high-voltage large-capacitance capacitor module according to one embodiment of the present invention;

FIG. 3 is a rear view of the case shown in FIG. 2;

FIG. 4 is an internal perspective view illustrating the configuration of an inverter of a vehicle to which a high-voltage large-capacitance capacitor module according to one embodiment of the present invention is applied;

FIG. 5 is a flowchart showing a procedure for manufacturing a high-voltage large-capacitance capacitor module according to one embodiment of the present invention;

FIG. 6 is a perspective view illustrating a state in which the multi-layer ceramic capacitor array is manufactured by boning multi-layer ceramic capacitors (MLCCs) on bus bars according to step S520 described with reference to FIG. 5;

FIG. 7 is a perspective view illustrating a state in which the multi-layer ceramic capacitor array is mounted on the case according to step S530 described with reference to FIG. 5; and

FIG. 8 is a perspective view illustrating a state in which the case is molded according to step S540 described with reference to FIG. 5.

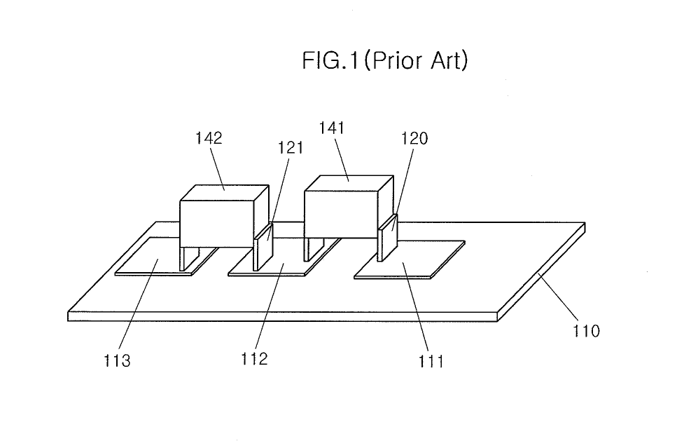

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure is thorough and complete, and fully conveys the scope of the present invention to those skilled in the art. Throughout the disclosure, like reference numerals refer to like parts throughout the various figures and embodiments of the present invention.

Like reference signs are used for like components in describing each drawing.

Although the terms like a first, a second, and the like are used to describe various components, the components should not be limited by the terms. The terms may be used for the purpose of distinguishing one component from another.

For example, a first component may be named a second component and similarly, a second component may be named a first component without departing from the scope of right of the present invention. The term and/or includes a combination of a plurality of related described items or any of the plurality of related described items.

Unless being otherwise defined, all terms used herein that include technical or scientific terms have the same meaning as those generally understood by those skilled in the art.

The terms, such as those defined in dictionaries generally used should be construed to have meaning matching that having in context of the related art and are not construed as ideal or excessively perfunctory meaning unless being clearly defined in this application.

Hereinafter, a capacitor module, a method for manufacturing the same, and an inverter having the same according to the present invention will be described below with reference to the accompanying drawings through exemplary embodiments.

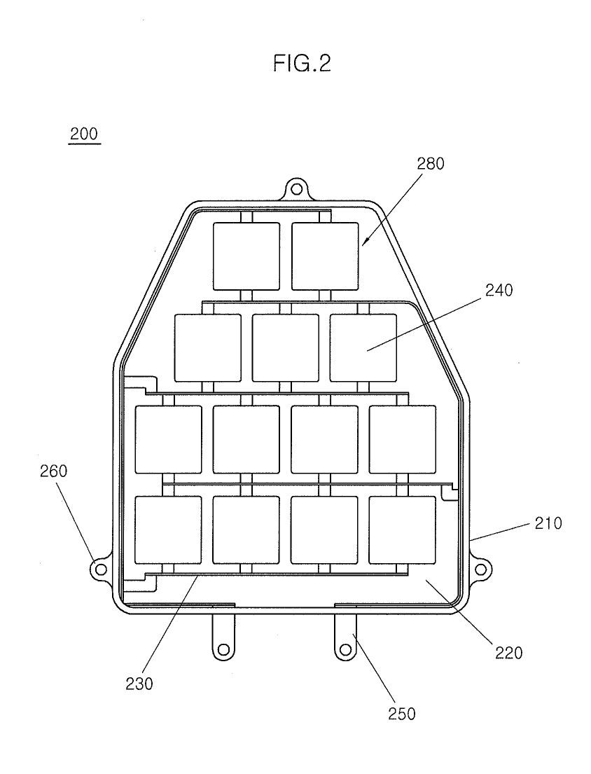

FIG. 2 is a conceptual view illustrating the configuration of a high-voltage large-capacitance capacitor module 200 according to one embodiment of the present invention. Referring to FIG. 2, the capacitor module 200 may be configured to include a case 210 having an open portion formed on one side thereof, and a multi-layer ceramic capacitor array 280 provided in the open portion.

The multi-layer ceramic capacitor array 280 may be configured in such a manner that a plurality of multi-layer ceramic capacitors (MLCCs) 240 are electrically coupled to a bus bar 230 and are disposed in parallel. However, the present invention is not limited thereto, and the plurality of multi-layer ceramic capacitors (MLCCs) 240 may be disposed in serial or in a mixed serial and parallel form.

The case 210 may function to allow the multi-layer ceramic capacitor array 280 to be assembled, and function to contain a molding material. To this end, the case 210 may have a structure in which the top surface thereof is open, the inner region thereof has a constant height, and the lateral faces thereof are blocked by lateral walls. In addition, the case 210 may be configured in the shape of a polygon so as to be assembled in an inverter, and may have three inverter fixing portions 260 formed on the side surface thereof.

The case 210 may have a coupling terminal 250 formed on the lower-end side surface thereof to be electrically coupled to circuit components configured in an inverter.

The material of the case 210 may be one selected from the group consisting of PolyPhenyleneSulfide (PPS), Carbon Fiber-Reinforced Plastic (CFRP), PolyButylene Terephthalate (PBT), PolyMethylMethAcrylate (PMMA), PolyAmide (PA), and PolyOxyMethylene (POM) resin. A combination of the materials may be used.

The plurality of multi-layer ceramic capacitors (MLCCs) 240 may be configured in a unit of about 20 μF to about 40 μF on capacitance so as to be assembled to the case 210 in the form of array. Generally, the conventional multi-layer ceramic capacitor (MLCC) is configured in a layer structure in which a dielectric layer (not shown) and an inner electrode layer (not shown) are mutually intersected.

Also, the conventional multi-layer ceramic capacitor (MLCC) is provided only for a low capacitance (i.e. low current), and is configured in the form of packaging mounted and used on a low-voltage PCB. Therefore, in order to use the MLCC as a direct current (DC) capacitor for a green vehicle according to one embodiment of the present invention, the MLCC must be mounted on the case 210 without an increase in the size and capacitance of the MLCC.

For this reason, the MLCC must be able to have a large capacitance while being small in size. To this end, the multi-layer ceramic capacitors (MLCCs) 240 may be configured to have a limited capacitance of about 20 μF to about 40 μF and to be provided in the form of an array so that the size of each multi-layer ceramic capacitor can be reduced.

That is because a direct current (DC) capacitor applied to an inverter for a vehicle is required to have a large capacitance and a high voltage. That is to say, that is because a voltage of 300-700 V and a capacitance of about 400 μF-about 700 μF are required.

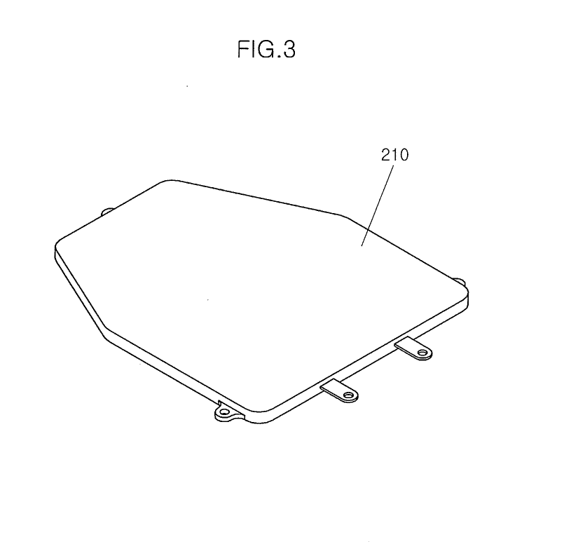

FIG. 3 is a rear view of the case 210 shown in FIG. 2. Referring to FIG. 3, the rear surface of the case 210 may be configured by injection molding so as to have the shape of a container in which all surfaces, except for the top surface thereof, are sealed.

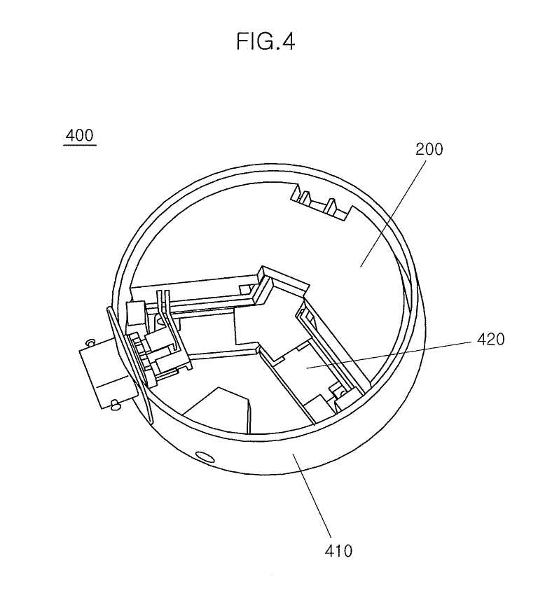

FIG. 4 is an internal perspective view illustrating the configuration of an inverter 400 of a vehicle to which a high-voltage large-capacitance capacitor module 200 according to one embodiment of the present invention is applied. Referring to FIG. 4, the capacitor module 200 may be mounted on a housing 410 of the inverter 400. The inverter 400 for a vehicle may be configured to include the housing 410, a switching element 420 provided on the bottom surface of the housing 410, and the capacitor module 200 electrically coupled to the switching element 420.

The switching element 420 may be configured with an isolated-gate bipolar transistor (IGBT), but the present invention is not limited thereto. The switching element 420 may be configured with a field effect transistor (FET), a bipolar junction transistor (BJT) for power, a metal-oxide-semiconductor field effect transistor (MOSFET), or the like.

In addition, the inverter 400 for a vehicle may be configured as an inverter integrated with a driving shaft, an inverter integrated with a wheel, or the like.

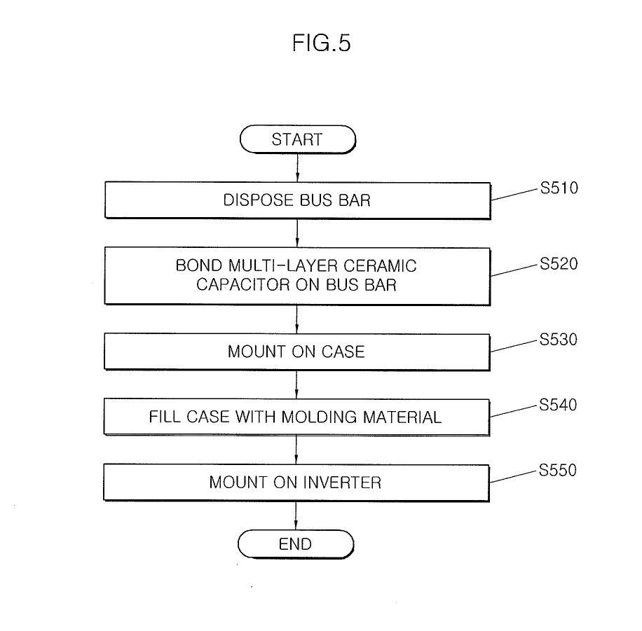

FIG. 5 is a flowchart showing a procedure for manufacturing the high-voltage large-capacitance capacitor module 200 according to one embodiment of the present invention. Referring to FIG. 5, a plurality of bus bars may be disposed at a predetermined interval in step S510.

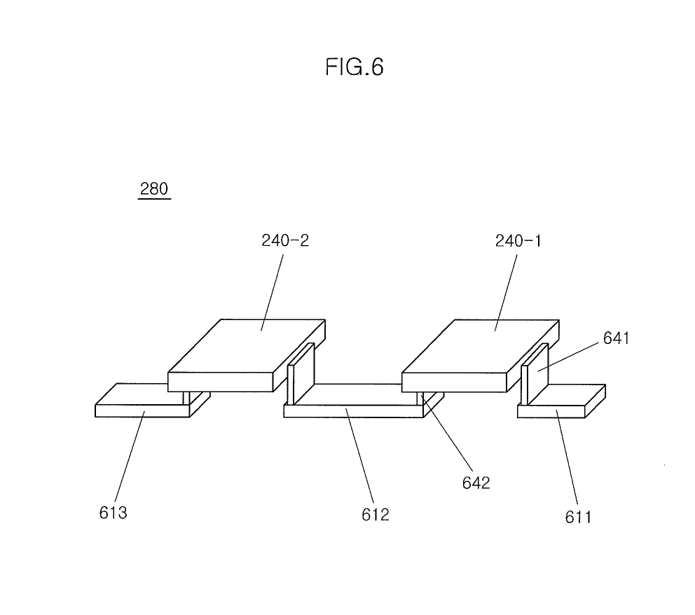

The multi-layer ceramic capacitors (MLCCs) 240 in FIG. 2 may be bonded on the plurality of bus bars to generate a multi-layer ceramic capacitor array in step S520. Such a bonding is illustrated in FIG. 6. A description on FIG. 6 will be given later.

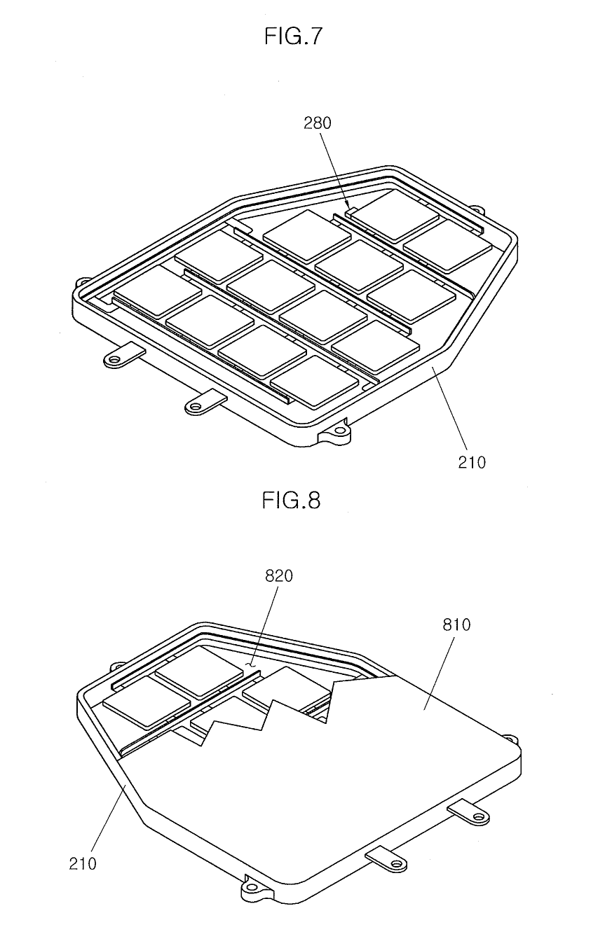

The generated multi-layer ceramic capacitor array may be mounted on the case 210 in FIG. 2, which has been prepared in advance, in step S530. Such a mounting is illustrated in FIG. 7. A description on FIG. 7 will be given later.

Molding material may be filled into an open portion of the case 210 and may be hardened in step S540. The hardening may be performed in a heat-curing scheme. However, the present invention is not limited thereof, and other normal hardening schemes may be employed. Such a hardening is illustrated in FIG. 8. A description on FIG. 8 will be given later.

A capacitor module is completed through steps S510 to SS530 described above. The completed capacitor module is mounted on an inverter for a vehicle in step S550.

FIG. 6 is a perspective view illustrating a state in which a multi-layer ceramic capacitor array 280 is manufactured by boning multi-layer ceramic capacitors (MLCCs) on bus bars according to step S520 described with reference to FIG. 5. Referring to FIG. 6, first to third bus bars 611, 612, and 613 may be aligned at a predetermined interval, and a first multi-layer ceramic capacitor 240-1 and a second multi-layer ceramic capacitor 240-2 may be bonded on the surfaces of the first to third bus bars 611, 612, and 613. In detail, the first multi-layer ceramic capacitor 240-1 may have a first lead portion 641 and a second lead portion 642 which are formed on both ends thereof. The lead portions 641 and 642 are electrode terminals wherein one may be electrically coupled to a “+” terminal, and the other may be electrically coupled to a “−” terminal. Accordingly, the first multi-layer ceramic capacitor 240-1 and the second multi-layer ceramic capacitor 240-2 can be electrically coupled to each other in a serial manner.

That is to say, the first lead portion 641 of the first multi-layer ceramic capacitor 240-1 may be bonded on the surface of the left end of the first bus bar 611, the second lead portion 642 of the first multi-layer ceramic capacitor 240-1 may be bonded on the surface of the right end of the second bus bar 612, and the lead portion of the second multi-layer ceramic capacitor 240-2 may be bonded on the surface of the left end of the second bus bar 612. When a plurality of multi-layer ceramic capacitors (MLCCs) are bonded in such a manner, the multi-layer ceramic capacitor array 280 is produced.

In this case, the bonding may be performed in a soldering manner. FIG. 6 illustrates a case where the plurality of multi-layer ceramic capacitors are electrically coupled in series. However, the present invention is not limited thereto, and the plurality of multi-layer ceramic capacitors may be bonded in parallel or in a serial and parallel mixed manner.

In addition, the plurality of bus bars 611, 612, and 613 may be made of aluminum or aluminum alloy. The aluminum series is light and has excellent conductivity. Accordingly, the weight and/or volume of a capacitor module can be reduced.

FIG. 7 is a perspective view illustrating a state in which the multi-layer ceramic capacitor array 280 is mounted on the case 210 according to step S530 described with reference to FIG. 5. Referring to FIG. 7, the multi-layer ceramic capacitor array 280 is mounted on the inside of the case 210.

FIG. 8 is a perspective view illustrating a state in which the case 210 is molded according to step S540 described with reference to FIG. 5. Referring to FIG. 8, in a state in which the multi-layer ceramic capacitor array 280 is disposed on the inside of the case 210, molding material may be filled into an open portion 820 of the case 210, and then may be heat-cured. For the molding material, a material which is robust against the vibration and/or impact of the capacitor module and has excellent heat conductivity in order to ensure a heat-dissipating performance may be used. Therefore, an epoxy series or a silicone series may be used as the molding material.

In accordance with the exemplary embodiments of the present invention, as compared with the conventional film-type capacitor which is heavy in weight and is large in size, a capacitor for a vehicle using the multi-layer ceramic capacitor (MLCC) is light in weight and is small in size, the size and weight of the capacitor for a vehicle can be reduced.

In addition, in accordance with the exemplary embodiments of the present invention, as compared with the conventional low-capacitance multi-layer ceramic capacitor (MLCC) package, an improved performance is shown in the circumstance of a vehicle, including a high temperature, vibration, impact, nose, and/or like.

In addition, in accordance with the exemplary embodiments of the present invention, capacitors for a vehicle are managed as one module, and a fastening bolt is used instead of soldering, so that the number of processes is reduced and a fastening method is facilitated on assembling of a made-in-plant (MIP) inverter, while each MLCC must be bonded on a printed circuit board (PCB) by soldering in the conventional low-capacitance multi-layer ceramic capacitor (MLCC) package.

In addition, in accordance with the exemplary embodiments of the present invention, the material cost for the conventional film-type capacitor sharply increases by four or five times on manufacturing thereof in order to ensure a high-temperature specification (i.e. 120° C. or higher) which is required in common for an inverter integrated with a driving shaft, an inverter integrated with a wheel, a large-current large-capacitance inverter, and the like. However, according to the present invention, the material cost can be reduced as compared with the conventional film-type capacitor because the MLCCs can be applied.

While the present invention has been described with respect to the specific embodiments, it will be apparent to those skilled in the art that various changes and modifications may be made without departing from the spirit and scope of the invention as defined in the following claims.

What is claimed is:

1. A capacitor module comprising:
a case comprising a recess; and
a multi-layer ceramic capacitor array provided in the recess, and comprising a plurality of multi-layer ceramic capacitors (MLCCs) disposed therein.

2. The capacitor module of claim 1, wherein the multi-layer ceramic capacitor array comprises:
a plurality of bus bars comprising a first bus bar and a second bus bar; and
wherein a first one of the plurality of multi-layer ceramic capacitors comprises a first lead connected to the first bus bar and a second lead connected to the second bus bar.

3. The capacitor module of claim 2, wherein the first and second leads are soldered to the first and second bus bars.

4. The capacitor module of claim 2, wherein the first one and a second one of the plurality of multi-layer ceramic capacitors electrically connected to the first bus bar and the second bus bar so as to form parallel connection.

5. The capacitor module of claim 4, wherein each of the plurality of multi-layer ceramic capacitors has a capacitance of about 20 μF to about 40 μF.

6. The capacitor module of claim 2, wherein the first and second bus bars comprise one of aluminum and aluminum alloy.

7. The capacitor module of claim 1, wherein material of the case comprises one or more selected from the group consisting of PolyPhenyleneSulfide (PPS), Carbon Fiber-Reinforced Plastic (CFRP), PolyButylene Terephthalate (PBT), PolyMethylMethAcrylate (PMMA), PolyAmide (PA), and PolyOxyMethylene (POM) resin.

8. The capacitor module of claim 1, wherein the recess is filled with a heat cured molding material covering the multi-layer ceramic capacitor array.

9. The capacitor module of claim 8, wherein the molding material comprises an epoxy resin or a silicone resin.

10. The capacitor module of claim 1, wherein the plurality of multi-layer ceramic capacitors are electrically coupled in series to each other.

11. An inverter for a vehicle comprising:
a housing;
a switching element mounted on a bottom surface of the housing; and
the capacitor module of claim 1 electrically coupled to the switching element.

12. The inverter of claim 11, wherein the inverter for a vehicle is one of an inverter integrated with a driving shaft and an inverter integrated with a wheel.

13. The inverter of claim 11, wherein the multi-layer ceramic capacitor array comprises:
a plurality of bus bars comprising a first bus bar and a second bus bar; and
wherein a first one of the plurality of multi-layer ceramic capacitors comprises a first lead connected to the first bus bar and a second lead connected to the second bus bar.

14. A method for manufacturing a capacitor module, comprising:
disposing a plurality of bus bars at a predetermined interval;
bonding a plurality of multi-layer ceramic capacitors on the plurality of bus bars to generate a multi-layer ceramic capacitor array;
mounting the multi-layer ceramic capacitor array on a case; and
filling the case with a molding material.

15. The method of claim 14, wherein the bonding is achieved in a soldering manner.

16. The method of claim 14, wherein each of the plurality of multi-layer ceramic capacitors has a capacitance of about 20 μF to about 40 μF.

17. The method of claim 14, wherein material of the plurality of bus bars is one of aluminum and aluminum alloy.

18. The method of claim 14, wherein material of the case comprises one or more selected from the group consisting of PolyPhenyleneSulfide (PPS), Carbon Fiber-Reinforced Plastic (CFRP), PolyButylene Terephthalate (PBT), PolyMethylMethAcrylate (PMMA), PolyAmide (PA), and PolyOxyMethylene (POM) resin.

19. The method of claim 14, wherein the molding material comprises an epoxy resin or a silicone resin.
